(19) United States
(12) Patent Application Publication
(10) Pub. No.: US 2026/0315912 A1
(43) Pub. Date: Oct. 15, 2026

(54) CONTROL OF ELECTRONIC GAMING SYSTEM

(71) Applicant: Sony Interactive Entertainment Inc., Tokyo (JP)

(72) Inventors: Angela Bartolome, SAN MATEO, CA (US); Peter Richardson, SAN MATEO, CA (US); Cristian Almstrand, SAN MATEO, CA (US); Nazia Latif, SAN MATEO, CA (US); Allison Yu, SAN MATEO, CA (US); Ritagya Meharishi, SAN MATEO, CA (US)

(21) Appl. No.: 19/174,502

(22) Filed: Apr. 9, 2025

(51) Int. Cl. A63F 13/24

(52) U.S. Cl. CPC A63F 13/24

(57) ABSTRACT

Methods, systems, and apparatus, including computer programs encoded on computer storage media, for controlling an electronic gaming system are featured. One of the methods includes obtaining receiving electrical energy data associated with one or more electrical energy sources for the electronic gaming system, the electrical energy data comprising electrical energy usage data or electrical energy supply data associated with the one or more electrical energy sources, determining, based on at least the electrical energy data for the one or more electrical energy sources, a time-varying attribute of the one or more electrical energy sources, selecting, based on at least the time-varying attribute of the one or more electrical energy sources, a period of time, and causing the electronic gaming system to initiate a function during the selected period of time.

### TECHNICAL FIELD

This specification relates to an electronic gaming system, particularly, control of an electronic gaming system.

### BACKGROUND

Electronic gaming systems incorporate one or more devices that allow users to engage with media in interactive and versatile ways. That is, gaming systems serve as multifunctional platforms for multiple use cases associated with different types of media. For example, users can interact with an electronic gaming system to play video games, to stream media, to download video games, to perform software updates, or to communicate with other users. As a result of this broad level of use, gaming systems allow for customization of a user's interaction with media based on individual information and preferences.

### SUMMARY

This specification describes technologies for adjusting power usage of an electronic gaming system based on a characteristic of an electrical energy source for supplying power to the electronic gaming system. An electronic gaming system can be configured to output media to a user, e.g., through an audiovisual interface, using hardware components and software components. For example, an electronic gaming system can include a gaming console, a user device, or a combination thereof to output media to the user. The gaming console can be a particular dedicated device configured to load and store media.

In some cases, during use of a gaming system to play a game, the gaming system can adjust its energy consumption during different time intervals. For example, the gaming system can implement one or more energy saving functions during time intervals when there is a high load on energy resources, time intervals when energy from sustainable energy sources is not available, or both. In this case, a control system can be configured to control the time periods during which each of the one or more energy saving functions are initiated.

In general, one innovative aspect of the subject matter described in this specification can be embodied in methods for controlling an electronic gaming system that include the actions of receiving electrical energy data associated with one or more electrical energy sources for the electronic gaming system. The electrical energy data can include electrical energy usage data or electrical energy supply data associated with the one or more electrical energy sources. The control system can then determine, based on at least the electrical energy data for the one or more electrical energy sources, a time-varying attribute of the one or more electrical energy sources. The control system can then select, based on at least the time-varying attribute of the one or more electrical energy sources, a period of time and cause the electronic gaming system to initiate a function during the selected period of time.

Other embodiments of this aspect include corresponding computer systems, apparatus, and computer programs recorded on one or more non-transitory computer storage devices, each configured to perform the actions of the methods.

The foregoing and other embodiments can each optionally include one or more of the following features, alone or in combination. For example, one embodiment includes all the following features in combination.

In some implementations, the control system can determine a geographical location and a time of the electronic gaming system and the electrical energy data includes electrical energy data specific to a region including the geographical location of the electronic gaming system.

In some implementations, the electrical energy data includes real-time electrical energy data and historical electrical energy data.

In some implementations, the time-varying attribute is a proportion of available electrical energy supply of the one or more energy sources being a type of electrical energy and the type of electrical energy includes one or more of (i) stored battery energy, (ii) solar energy, (iii) wind energy, (iv) hydroelectric energy, (iv) geothermal energy, or (v) nuclear energy.

In some implementations, the time-varying attribute is an electrical energy load on the one or more electrical energy sources.

In some implementations, the one or more electrical energy sources includes an on-site electrical energy system configured to supply electrical energy to the electronic gaming system.

In some implementations, the one or more electrical energy sources include electrical energy sources and the electrical energy sources further include an off-site electrical energy source configured to supply electrical energy to the electronic gaming system.

In some implementations, the time-varying attribute corresponds to a proportion of available electrical energy of the on-site electrical energy source, and the electrical energy configured to be supplied by the on-site electrical energy source is generated by a renewable energy source.

In some implementations, selecting the period of time includes predicting a value of the time-varying attribute during the period of time.

In some implementations, the function includes download of a game to the electronic gaming system or download of a patch update to the electronic gaming system, and the download of the game or the download of the patch update includes a download at a reduced speed.

In some implementations, the function includes presentation of a recommendation to a user of the electronic gaming system to alter a behavior of the user for using the electronic gaming system.

In some implementations, the function results in a change in power consumption of the electronic gaming system.

In some implementations, the function includes an adjustment of one or more characteristics of imagery generated by the electronic gaming system.

In some implementations, the one or more characteristics of the imagery comprise frame rate.

In some implementations, the one or more characteristics of the imagery comprise brightness.

In some implementations, the one or more characteristics of the imagery comprise resolution.

In some implementations, the function includes use of a cloud version of the game during the period of time.

Advantages of the systems and methods described in this disclosure may include those described below and elsewhere in this disclosure.

By controlling the energy consumption of an electronic gaming system and the period of time that the gaming system is operated, the technology described herein expands the gaming system's energy efficiency and sustainability. That is, the described techniques allow for the energy consumed by the gaming system to be more sustainably sourced. It is desirable for a user to use the gaming system during time periods when the electrical energy used by the gaming system is from either on-site or off-site sustainable energy sources. Sustainable energy sources can, for example, include solar panels, wind turbines, geothermal energy sources, hydraulic energy sources, nuclear energy sources, etc. In particular, the gaming system can be controlled to reduce energy consumption during certain periods of time, e.g., when there is a high load on energy sources, times when low amounts of energy from sustainable energy sources is available, or both. For example, the system can obtain electrical energy data, and the system can use the electrical energy data to determine time windows when particular types of energy are available.

The system can select time windows for specific functions to be initiated based on the types of energy available at the time windows. Initiating functions, such as functions for regular speed game downloads and updates, at time periods where sustainable or renewable energy is available, or where less nonrenewable energy is consumed, allows the system to increase sustainable power consumption at these times. Additionally, the system can initiate energy saving functions that reduce energy consumption of the gaming system during time periods where sustainable or renewable energy is not available, or when more nonrenewable energy is consumed. For example, the energy saving functions can include a function that decreases the speed of game downloads and updates. As another example, the energy saving functions can include a function that encourages a user to reduce energy consumption of the gaming system during the time period. The initiation of the function during the time period can ensure that the gaming system consumes energy from sustainable energy sources more than unsustainable energy sources and that the gaming system consumes less energy during time periods when energy is more expensive.

Furthermore, the described techniques, allow for the customization of which functions are initiated during the selected time windows. A user can personalize the functions that are initiated during specific time windows according to individual preferences. This can enhance a user experience when using the gaming system, rather than automatically initiating functions that may interfere with the user's priorities.

The described techniques allow a gaming system to provide the same functionalities that it would usually provide in a more sustainable way. Providing a user with the option to personalize functions based on selected time windows enables the gaming system to encourage certain user behaviors that would improve sustainability of the gaming system without significantly impacting user gameplay experience. Limiting energy saving functions to time periods with less sustainable energy available allows a user experience to remain unimpacted during all other the time periods.

Additionally, the described techniques enable receiving and using real-time energy usage and supply information to adapt the operations of the gaming system. When fluctuations in energy consumption on the power grid occur, the system can dynamically adapt time windows for initiating the functions. For example, when less sustainable energy is available than typical during a particular time period, the system may select that time window for initiating an energy saving function.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIG. 1 is a diagram of an example system that controls an electronic gaming system.

FIG. 2 is a flowchart of an example process for controlling the gaming system.

FIG. 3 shows a display of the gaming system presenting a representation of a user-selectable time period for controlling the gaming system.

FIG. 4 shows a display of the gaming system presenting a representation of user-selectable settings for controlling the gaming system.

FIG. 5 is a diagram showing, conceptually, communication among the gaming system, a server, and one or more databases.

FIG. 6 is a block diagram of a computing system that can be used in connection with computer-implemented methods described in this specification.

Like reference numbers and designations in the various drawings indicate like elements.

### DETAILED DESCRIPTION

This document describes technology that enables an electronic gaming system to adjust energy usage at different time points based on available energy from one or more energy sources from which the gaming system can draw energy. This technology can potentially increase energy efficiency and sustainability of operations of the gaming system. To adjust the energy usage of the gaming system, various types of information—such as location where and time of day when the gaming system is being operated, energy availability from the one or more energy sources, and user preferences—can be used to determine time-varying attributes of energy associated with the one or more energy sources. A control system can select time periods during which various functions of the gaming system—such as, for example, downloading, updating, changing download or update speed, and changing image quality—are initiated based on the time-varying attributes. The time-varying attributes can be, for example, an electrical load on the one or more energy sources or an availability of energy from a particular type of energy source of the one or more energy sources. This in turn can be used to control the energy usage of the gaming system. For example, when less energy is available, the gaming system can initiate functions for reducing speed of downloads and quality of images or initiate functions for deferring downloading and updating to times when more energy is available. Similarly, when renewable energy is not available, the gaming system can initiate functions for reducing speed of downloads and quality of images or initiate functions for deferring downloading and updating to times when renewable energy is available. Controlling the time periods during which functions are initiated allows the gaming system to reduce energy consumption at times when less energy is available and at times when renewable energy is not available.

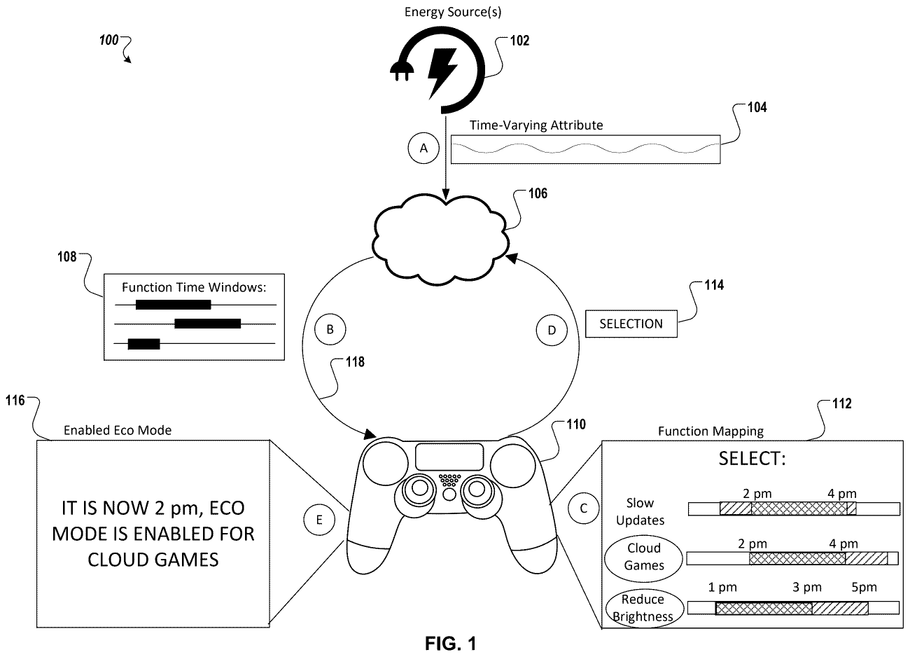

FIG. 1 is a block diagram of an example system 100 that controls an electronic gaming system 110 (e.g., visually represented in FIG. 1 by an external controller of the gaming system) in accordance with technology described in this disclosure. The system 100 includes one or more servers 106, one or more energy sources 102, and the gaming system 110. Although a single gaming system 110 is depicted in FIG. 1, the system 100 enables coordination among several gaming systems located across multiple areas.

The one or more servers 106 are connected to the gaming system in a network 118. The one or more servers 106 can be configured to, for example, provide updates to the gaming system 110, perform game downloads to the gaming system, enable multiple users of the gaming system to interact with each other, and control the operations of the gaming system. More specifically, the one or more servers 106, can be configured to control time periods for initiating particular functions of the gaming system as discussed in further detail below.

The one or more energy sources 102 are configured to supply electrical energy to the gaming system. An energy source of the one or more energy sources 102 can include an on-site electrical energy system or an off-site electrical energy system. An on-site electrical energy system can produce electrical energy at an area, e.g., a home, a school, another type of building, etc., where the gaming system 110 is located and provide the produced electrical energy to the gaming system. An on-site electrical energy system can include for example, one or more solar energy sources e.g., solar panels, one or more wind energy sources, e.g., wind turbines, one or more battery energy sources, e.g., stored batteries, one or more generators, or any combination thereof. The area can be connected to an energy grid (including one or more off-site electrical energy systems) that supplies energies to multiple areas, and the on-site electrical energy system can supply energy to the area even if the energy grid is temporarily unable to supply energy to the area, e.g., due to a blackout, brownout, or other power outage scenario.

An off-site electrical energy system can be operated, for example, by a power company and be located at an area, e.g., a power plant, that is different from the location of the gaming system 110. An off-site electrical energy system can generate electrical energy from a variety of electrical energy sources, e.g., chemical energy sources, heat energy sources, hydroelectric energy sources, mechanical energy sources, geothermal energy sources, nuclear energy sources, solar energy sources, wind energy sources, stored battery energy sources, oil energy sources, natural gas energy sources, coal energy sources, nuclear energy sources, etc., and transmit the electrical energy to various substations that can distribute the electrical energy to nearby locations, e.g., homes, businesses, etc., over a power grid.

The electronic gaming system 110 is configured to output media to a user using hardware components and software components, such as an operating system. The gaming system 110 can include a display, a gaming console, or a combination thereof to output media to the user. The gaming console can be a particular dedicated device configured to load and store media. The gaming console can be coupled to the display (e.g., a television, monitor, etc.). In some examples, the gaming console can be coupled to external controllers that can provide input for interacting with the media. For example, a user playing a video game can load the video game on the gaming console, and the user can interact with the video game via the user device, the external controller, or both. Although FIG. 1 shows the external controller 110 of the gaming system, in implementations, the gaming system may not include an external controller or may include a different modality or different type of controller for the user to provide a user-selected input to the gaming system, as discussed in greater detail in this disclosure.

The system 100 can share resources and communicate between devices (e.g., including the gaming system, using a network 118. The network 118 can be a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN), all or a portion of the Internet, or any other communication system or systems at one or more locations. or a combination of communication networks. The network can communicate with, for example, Internet Protocol (IP) packets, frame relay frames, asynchronous transfer mode (ATM) cells, voice, video, data, or a combination of communication types between network addresses.

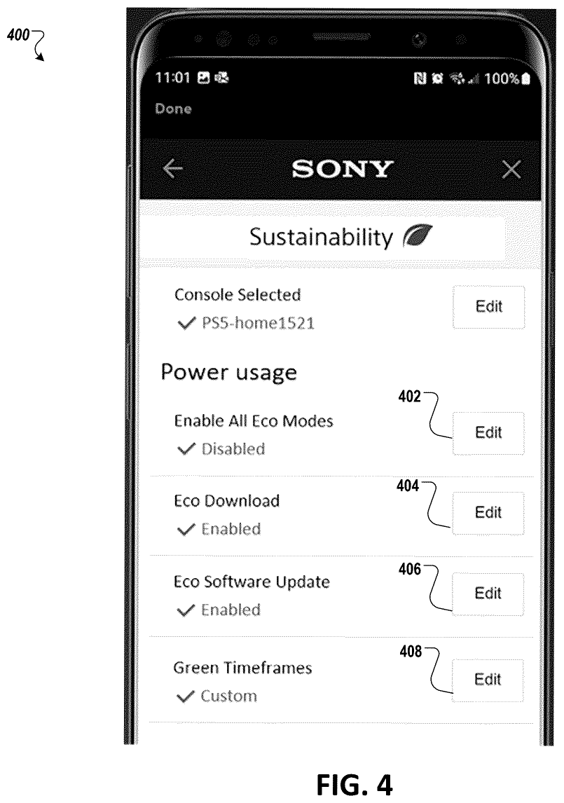

The system 100 can also receive contextual data from the gaming system 110 over the network 106. The contextual data can include time information and/or location information associated with the gaming system itself or with a user of the gaming system. The time information can include a time of day or a time of year. In some examples, the contextual data can include user customization data, which represents information unique to the particular user of the gaming system 110. The user customization data can include historical user data, feedback data, and/or user preference data, as described in further detail below with reference to FIG. 4. The historical user data can include historical information associated with previous interactions with media using the gaming system.

The system 100 can receive electrical energy data associated with the one or more energy sources 102 over the network 106 and, as discussed in greater detail in this disclosure, use the electrical energy data to facilitate energy-efficient and sustainable operation of the gaming system. The electrical energy data can include historical energy data, real-time energy data, near-real time energy data, or any combination thereof. The electrical energy data can include, for example, energy supply data, energy usage data, or both associated with each of the energy sources 102. The electrical energy data can be specific for a geographic location of the gaming system 110. In some examples, the geographic location can be a property e.g., a house, a business, other building, etc., where the gaming system is located. In other examples, the geographic location can be a geographic region. e.g., a city, a county, a power grid region, etc., that the gaming system is located within.

Energy usage data can characterize electrical energy usage by a site where the gaming system 110 is located and/or electrical energy usage by all sites that an energy source provides energy to. Energy usage data can include, for example, an average amount of electrical energy used from a particular electrical energy source by a property where the gaming system 110 is located or by all locations within a geographical region that the gaming system is located within during each of a series of time intervals. The series of time intervals can be, for examples, each hour of a day, each hour of a particular day of the week, each minute of a day, each 20-minute period in a week, etc. In some examples, the energy usage data can include an amount of electrical energy currently being used from a particular electrical energy source e.g., that 70% of energy from a wind turbine is currently in use, that 20% of energy from an on-site generator is currently in use, etc.

In some examples, the energy usage data can include percentages of electrical energy used from each of multiple sources at a specific time point for the property and/or on average across the geographical region where the gaming system 110 is located. For example, the energy usage data can indicate that from 9-10 a.m., 70% of energy used is from solar energy sources and 30% of energy used is from wind energy sources and that from 5-6 p.m., 50% of energy used is from geothermal energy sources, 40% of energy used is from oil energy sources, and 10% of energy used is from wind energy sources.

Energy supply data can characterize electrical energy supply for a site where the gaming system 110 is located and/or electrical energy supply for all sites that an energy source provides energy to. Energy supply data can include, for example, an average amount of electrical energy available from a particular source for a property where the gaming system 110 is located or for all locations within a geographical region that the gaming system is located within during each of a series of time intervals. The series of time intervals, can be, for example, each hour of a day, each two-hour period of a particular day of the week, each minute of a day, each 30-minute period in a week, etc. In some examples, the energy usage data can include an amount of energy that is currently available to be used from a particular source e.g., that 100% of energy from a solar panel is currently available, that 35% of energy from a battery is currently available, etc.

In some examples, the energy supply data can include percentages of electrical energy supplied to the property and/or on average across the geographical region where the gaming system 110 is located from each of multiple sources at a specific time point. For example, the energy supply data can indicate that from 3-4 a.m., 50% of available energy is from solar energy sources and 50% of available energy is from oil energy sources and that from 1-2 p.m., 30% of available energy is from wind energy sources, 45% of available energy is from natural gas energy sources, and 25% of available energy is from solar energy sources.

The system 100 determines, using the electrical energy data, a time-varying attribute 104 of the energy source(s) 102. The time-varying attribute 104 can be a characteristic of the electrical energy data the changes over time. The system can process the electrical energy data to determine values of the time-varying attribute 104 for multiple time intervals by mapping data points to the time intervals. The time intervals can be, for example, hours of a day, minutes of a day, etc. The system can process the electrical energy data using mathematical operations, manual data processing techniques, automatic data processing techniques, batch data processing techniques, etc. The system 100 can use the electrical energy data to forecast time periods when specific types of energy e.g., renewable energy, efficient energy, etc., is available.

In some examples, the time-varying attribute 104 can be a proportion of available energy supply of the one or more energy sources 102 being a type of electrical energy. For example, the time varying attribute 104 can be the proportion of energy supplied to the geographic region that is from sustainable energy sources e.g., solar energy sources, wind energy sources, hydroelectric energy sources, geothermal energy sources, nuclear energy sources, etc. As another example, the time varying attribute 104 can be the proportion of energy supplied to the geographic region that is from solar energy sources specifically. The system can characterize the time intervals where more than a predetermined amount, e.g., 50%, 60%, 70%, of the available energy supply is the type of electrical energy as ‘sustainable’, ‘green’, ‘renewable’, or ‘eco-friendly’, and the other time intervals as ‘not sustainable’, ‘not green’, ‘not renewable’, or ‘not eco-friendly’.

In some examples, the time-varying attribute 104 can be an energy load on the one or more electrical energy sources 102. For example, the time varying attribute 104 can be whether more than a predetermined amount e.g., 70%, 80%, 95%, of energy from the electrical energy sources 102 is available. The system can characterize the time intervals where above the predetermined amount of energy is available as ‘off-peak’, ‘somewhat efficient’, ‘very efficient’, or ‘efficient’, and the other time intervals as ‘peak’or ‘inefficient’.

In some examples, the time-varying attribute 104 can correspond to a proportion of available electrical energy of an on-site electrical energy source. For example, the time varying attribute 104 can be whether more than a predetermined amount e.g., 20%, 30%, 45%, of the available energy supply is from on-site energy sources. The on-site energy sources can include batteries, solar panels, wind turbines, etc. The system can characterize the time intervals where above the predetermined amount of available energy is from on-site sources as ‘local’, and the other time intervals as ‘non-local’. As another example, the time varying attribute 104 can be whether more than a predetermined amount e.g., 50%, 70%, 85%, of energy from on-site energy sources is available. The system can characterize the time intervals where above the predetermined amount of energy from on-site sources is available as ‘local’, and the other time intervals as ‘non-local’.

The system 100 can select, based on the time-varying attributes 104, windows 108 of time for initiating one or more particular functions of the gaming system. The system 100 can predict values of the time-varying attributes for particular time periods e.g., using a machine learning technique, using prediction software, using statistical techniques, by averaging data values, etc. The system 100 can determine, based on the predicted values, whether a particular time period is characterized as ‘efficient’ or not, ‘sustainable’ or not, ‘local’ or not, etc. The system 100 can select time periods with specific characterizations for different functions. The system 100 can select functions that decrease energy usage by the gaming system 110 during time periods that are characterized as inefficient, e.g., when energy is more expensive, when there is a higher load on electrical energy sources, etc., or unsustainable, e.g., when electrical energy from sustainable or renewable energy sources are not available.

In some examples, the system can select the windows 108 of time based on the location of the gaming system. The threshold amount of energy available to characterize a time period as ‘efficient’ or the threshold amount of available renewable energy to characterize a time period as ‘sustainable’ can very from area to area. For example, one area might generally have more renewable energy sources than other areas. The threshold percentage for selecting a time period for initiating a function can be a percentage of renewable energy sources that are available in the area rather than a percentage of all energy sources in the area that are renewable. As an example, in an area where more renewable energy sources are generally available, the criteria for selecting a time period as ‘sustainable’ can be that 70% of all available energy in the area is from sustainable sources, while in an area where more renewable energy sources are generally available, the criteria for selecting a time period as ‘sustainable’ can be that 60% of energy from sustainable energy sources in the area is available.

For example, the system 100 can select a time period for initiating one or more particular functions as ‘sustainable’ for a particular city based on 60% of available energy during that time period being from sustainable energy sources such as wind turbines and solar panels. In another city that has less renewable energy sources, the system 100 can select a time period for initiating the same one or more particular functions as ‘sustainable’ for the city based on 20% of available energy during that time period being from sustainable energy sources.

In some examples, when fluctuations in energy consumption on the power grid occur, the system can dynamically adapt the selected time windows. For example, when less sustainable energy is available than typical during a particular time period on a specific day, the system may select that time window for initiating a particular function and classify that time period as ‘unsustainable’ for that day only.

The particular functions can include, for example, a download of a game to the gaming system 110 or download of a patch update to the gaming system. In some examples, the function can be a download or a game or a download of a patch update at a reduced speed or a deferment of the download or patch update. In some examples, the function can be a single download of a specific game to the gaming system 110. For example, the system 100 can select time windows 108 characterized as ‘off-peak’, ‘efficient’, ‘sustainable’, ‘green’, ‘eco-friendly’ and/or ‘local’ to download games or patch updates at regular speeds. The system can select time windows 108 characterized as ‘peak’, ‘not efficien’, ‘not sustainable’, ‘not renewable’, ‘not green’, ‘not eco-friendly’ and/or ‘not local’ to download games and download patch updates at reduced speeds or to defer the downloads to an efficient or sustainable time interval. Downloading games and patch updates at reduced speeds can decrease energy consumption by the gaming system 110. Deferring downloads and patch updates can reduce energy consumption by the gaming system during time periods when less energy is available or time periods when less sustainable energy is available.

The particular functions can include, for example, the presentation of a recommendation to a user of the electronic gaming system to alter a behavior of the user for using the electronic gaming system. For example, the system 100 can select time windows 108 characterized as ‘peak’, ‘not efficient’, ‘not sustainable’, ‘not green’, ‘not renewable’, ‘not eco-friendly’ or ‘not local’ to present a recommendation to the user to alter a behavior. The recommendation can include, for example, a recommendation to play at later time window that is characterized as ‘off-peak’, ‘efficient’, ‘sustainable’, ‘green’, ‘renewable’, ‘eco-friendly’ and/or ‘local’ instead. The recommendation can include, for example, a recommendation to reduce a brightness of imagery displayed by the gaming system 110. The user following a recommendation to alter behavior can reduce energy consumption by the gaming system 110 during inefficient or unsustainable time intervals.

The particular functions can include, for example, an adjustment of one or more characteristics of imagery generated by the gaming system 110. The characteristics of imagery can be, for example, the frame rate, the brightness, and/or the image resolution. For example, the system 100 can select time windows 108 characterized as ‘off-peak’, ‘efficient’, ‘sustainable’, ‘green’, ‘eco-friendly’ and/or ‘local’ to increase to a regular frame rate, brightness, and resolution. The system can select time windows 108 characterized as ‘peak’, ‘not efficient’, ‘not sustainable’, ‘not green’, ‘not eco-friendly’ and/or ‘not local’ to adjust to a reduced frame rate, brightness, and resolution. Reducing characteristics of generated imagery can reduce energy consumption by the gaming system 110.

The particular functions can include, for example, a function that offloads at least some of the processing performed by the gaming system to a remote server. For example, the function can include using a cloud version of a game during a time interval, e.g., a game stored on a server, such as the server 106, to which the gaming system is connected. For example, the system 100 can select time windows 108 characterized as ‘peak’, ‘not efficient’, ‘not sustainable’, ‘not green’, ‘not eco-friendly’ and/or ‘not local’ to use a cloud version of the game. By using a cloud version of the game instead of a local copy of the game, the gaming system offloads some of the processing required for operating the game to the server that hosts the cloud version of the game and thus consumes less energy.

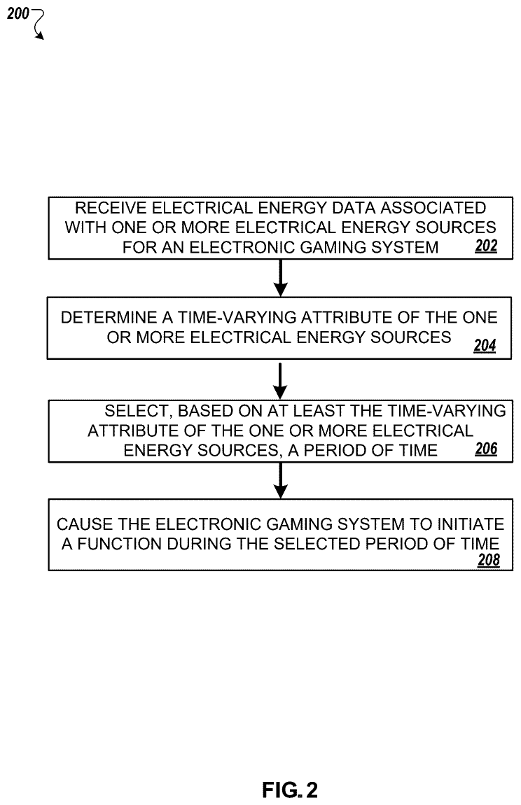

FIG. 2 is a flow diagram of an example process for controlling the gaming system 110. The process 200 can be executed, for example, by a system of one or more computers, located in one or more locations, and programmed appropriately in accordance with this specification. For example, a system, e.g., the system 100 of FIG. 1, appropriately programmed, can perform the process 200. Although specific examples of data (e.g., electrical energy data), gaming system functions, electrical energy sources, time-varying attributes, and other features are described below in connection with the operations 202, 204, 206, 208 of the process 200 depicted in FIG. 2, further examples are described elsewhere in this disclosure.

Operations of the process 200 include receiving electrical energy data associated with one or more electrical energy sources (e.g., the one or more electrical energy sources 102 of FIG. 1) for an electronic gaming system (e.g., the gaming system 110 of FIG. 1) (202). The electrical energy data includes electrical energy usage data or electrical energy supply data associated with the one or more electrical energy sources (e.g., the electrical energy data described in connection with the one or more electrical energy sources 102 of FIG. 1). The electrical energy can data include both real-time electrical energy data and historical electrical energy data.

In some examples, the system 100 can determine a geographical location and a time of the electronic gaming system, as described in connection with the gaming system 110 of FIG. 1. The electrical energy data can be electrical energy data specific to a region that includes the geographical location of the electronic gaming system.

In some examples, the one or more electrical energy sources can include an on-site electrical energy system (e.g., the on-site electrical energy system described in connection with FIG. 1) configured to supply electrical energy to the electronic gaming system. The electrical energy configured to be supplied by the on-site electrical energy source can be energy generated by a renewable energy source. In some examples, the one or more electrical energy sources includes an off-site electrical energy source configured to supply electrical energy to the electronic gaming system.

Operations of the process 200 also include determining, based on at least the electrical energy data for the one or more electrical energy sources, a time-varying attribute (e.g., the time-varying attribute 104 described with respect to FIG. 1) of the one or more electrical energy sources (204).

In some examples, the time-varying attribute is a proportion of available electrical energy supply of the one or more energy sources being a type of electrical energy. The type of electrical energy can include one or more of (i) stored battery energy, (ii) solar energy, (iii) wind energy, (iv) hydroelectric energy, (iv) geothermal energy, or (v) nuclear energy. In some examples, the time-varying attribute is an electrical energy load on the one or more electrical energy sources. In other examples, the time-varying attribute corresponds to a proportion of available electrical energy of the on-site electrical energy source.

Operations of the process 200 also include selecting, based on at least the time-varying attribute of the one or more electrical energy sources, a period of time (206). As described with respect to FIG. 1, the period of time can be selected to improve sustainable operation of the gaming system. The system 100 can predict a value of the time-varying attribute during the period of time to select the period of time.

Operations of the process 200 also include causing the electronic gaming system to initiate a function (e.g., a function of the gaming system 110 for facilitating sustainable operation of the gaming system 110 as described in connection with FIG. 1) during the selected period of time (208).

In some examples, the function of the electronic gaming system includes a download of a game to the electronic gaming system or download of a patch update to the electronic gaming system. The download of the game or the download of the patch update can be a download at a reduced speed. In some examples, initiating the function can include initiating a download function for a single download of a game.

In some examples, the function is a presentation of a recommendation to a user of the electronic gaming system to alter a behavior of the user for using the electronic gaming system. In some examples, the function includes use of a cloud version of the game during the period of time. In some examples, the function is an adjustment of one or more characteristics of imagery generated by the electronic gaming system. The one or more characteristics of the imagery can be one or more of (i) frame rate, (ii) brightness, or (iii) resolution.

In some examples, the system 100 can initiate a sustainability mode of the electronic gaming system. When the system 100 initiates a sustainability mode, the system can initiate the function during the period of time and when the electronic gaming system is in the sustainability mode. In some examples, the system can initiate the function in response to the electronic gaming system being in the sustainability mode. The system 100 can allow a user to select a setting of the sustainability mode. Selecting the setting can include selecting a subset of functions of the electronic gaming system that are only initiated during the period of time. The system 100 can present an indicator of the period of time and receive a user input to initiate the sustainability mode.

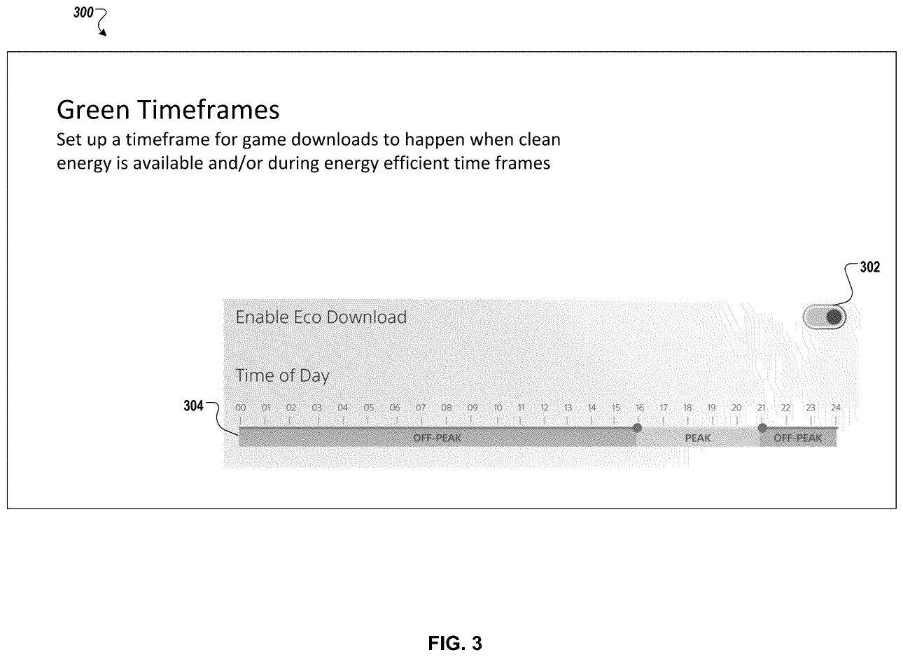

FIG. 3 shows a display 300 of the gaming system 110 displaying an option for controlling the gaming system. The display can be, for example, a television or a computer screen of the gaming system 110 that outputs media to a user. The display 300 can present the user with a time window 304 during which electrical energy sources for the gaming system 110 have a high electrical energy load. For example, the time window between 16:00 and 21:00 can be characterized as ‘peak’ electrical hours and all other times can be characterized as ‘off-peak’ electrical hours. The user can select a button 304, e.g., using an external controller of the gaming system 110, to enable or disable a sustainability mode. When the user selects to enable a sustainability mode, the gaming system can perform downloads of games and/or patch updates during off-peak time intervals e.g., before 16:00 and after 21:00.

The gaming system 110 can present the user with selected time windows for multiple particular functions that the user can choose to enable or disable. A particular example of presenting a user with options for selecting time windows for multiple particular functions is illustrated in FIG. 1. The system 100 can present a function mapping 112 that visually illustrates time windows that particular functions of the gaming system are initiated to improve sustainable operation of the gaming system. The system 100 can present the function mapping 112 to a user of the gaming system 110 on the display. The gaming system 110 can receive the function mapping 112 over the network 118. The function mapping can include the respective selected time windows 108 for one or more of the particular functions. The selected time windows indicate periods of time selected for the one or more particular functions.

In response to presenting the function mapping 112 to the user, the gaming system 110 can receive a user input to initiate a sustainability mode. When the system 100 is in the sustainability mode, the system can initiate the particular functions during the selected time windows. The system 100 can present the user with options to select settings of the sustainability mode. The system 100 can receive a user input that indicates a subset of the one or more particular functions to initiate during their respective selected time windows. The user can choose a selection 114 of which functions to implement or to not implement during sustainable or efficient time periods.

For example, as illustrated in FIG. 1, the function mapping can show time windows that are selected for initiating functions for downloading updates at a reduced speed, using cloud versions of games, and reducing the brightness of imagery generated by the gaming system 110. For example, the selected time windows can be unsustainable or inefficient time intervals. For example, the time window selected for downloading updates at a reduced speed can be 2-4 p.m., the time window selected for using cloud versions of games can be 2-4 p.m., and the time window selected for reducing the brightness of the imagery can be 1-3 p.m. 2-4 p.m. can be, for example, a ‘non green’ time window and 1-3 p.m. can be, for example, an ‘inefficient’ time window. The user can select that the system 100 should initiate functions for using cloud versions of games and reducing the brightness of the imagery at the selected time windows and the system should not initiate a function for downloading games at a reduced speed during any time windows.

The system 100 can initiate the functions that the user selected to implement during the selected time windows. The system 100 can receive the selection 114 by the user of which functions to implement or to not implement during sustainable or efficient time periods over the network 118 and determine that the functions selected by the user should by initiated during the selected time windows.

For example, as illustrated in FIG. 1, at 2 p.m., the system can initiate a function to use cloud versions of video games. The system can present a message 116 to the user of the gaming system 110 that the function to use cloud versions of video games is being initiated. The message 116 can characterize initiating the function as enabling an ‘Eco Mode’. The “Eco Mode’ can describe that the system 100 is reducing energy consumption during time periods that use a high proportion of unsustainable energy. At 4 p.m., the gaming system 110 can stop using cloud versions of video games and switch back to standard versions of video games.

In some examples, the system 100 can present one or more messages to the user to incentivize or encourage the user to use functions of the system that reduce energy consumption. For example, the system can determine a reward, e.g., a prize, for the user achieving an incentive and present an indicator of this reward. For example, if the user selects to enable the ‘Eco Mode’ for a proportion of playing time, e.g., 50% of the operating time, the system 100 can present the user with an ‘Eco Trophy.’ The ‘Eco Trophy’ can be, for example, a badge presented on the display 300. As another example, if the user selects to initiate a predetermined number, e.g., 4, 6, 7, etc., of energy saving functions, the system 100 can present the user with an option to display a ‘Green’label along with a username of the user.

In some examples, the system 100 can generate a user-oriented sustainability report and present the report to the user via the display 300. The sustainability report can include, for example, user-specific energy consumption metrics, goals reached by the user, rewards earned by the user, user-specific energy reduction metrics, etc.

In some examples, the system 100 can present the user with a specific section of or the entirety of a user-oriented sustainability report for each of one or more other users. The system 100 can use information from the user-oriented sustainability reports to present the user with a comparison of the user's sustainability metrics with one or more other users'sustainability metrics. In some examples, the system can present the user with sustainability metrics for a predetermined number, e.g., 8, 10, 15, etc., of randomly sampled other users within the same geographical region as the user. The system 100 can rank the user and the sampled other users in the same geographical region based on their sustainability metrics.

In some examples, the system 100 can send an inbox message to the user via the display 300. The inbox message, can for example, be a congratulatory message if the user reached a sustainability goal or earns a reward. As another example, the inbox message can be a periodic message to view a specific section or the entirety of the sustainability report.

FIG. 4 shows a display 400 of the gaming system 110 displaying settings for controlling the gaming system. The display 400 can be, for example, a mobile device or computer belonging to a user of the gaming system. The display 400 can present the user with options 402, 404, 406, and 408 for selecting and modifying functions for controlling the gaming system. The user can choose to enable or disable all sustainability modes 402, to enable or disable sustainable download functions 404, to enable or disable sustainable update functions 406, or to customize which functions to use during sustainable time windows 408. For example, the user can choose to enable sustainable download functions, and the gaming system 110 can then initiate functions for reduced speed downloads during unsustainable time windows and perform regular speed downloads during sustainable time periods.

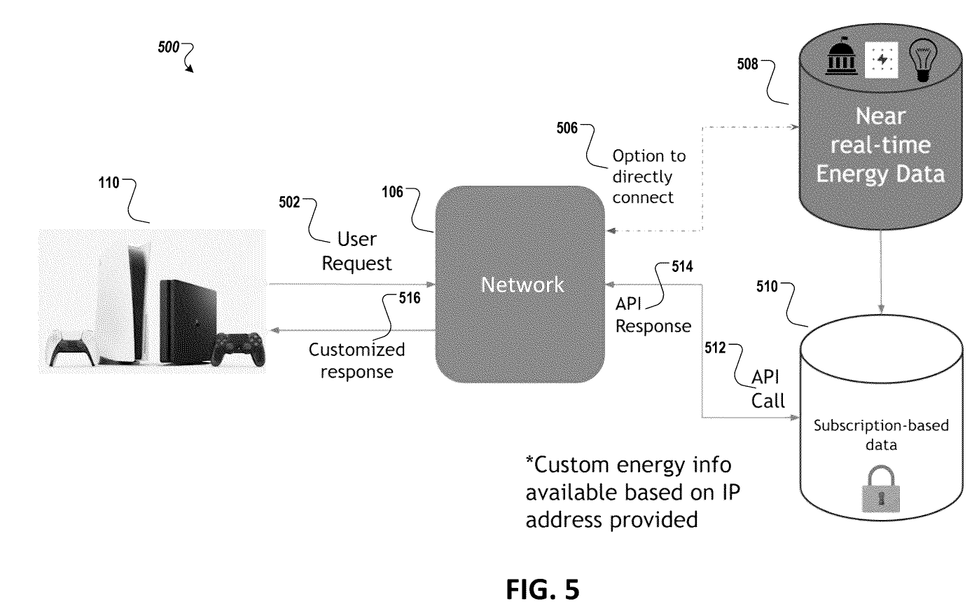

FIG. 5 is a diagram showing, conceptually, an example 500 of communication among the gaming system 110, a server 106, and one or more databases 508 and 510.

The server 106 can receive a user request 502 from the gaming system 110 to utilize a sustainability mode or to initiate a function of the gaming system. The server 106 can retrieve electrical energy data (e.g., the electrical energy data received from the one or more electrical energy sources 102 of FIG. 1) from one or more databases 508 and 510.

The databases can include a near-real time electrical energy information database 508 and a subscription based electrical energy information database 510. The near-real time electrical energy information database 508 can include information from sensors, power meters, power or utility company applications and websites, etc. The near-real time electrical energy information database 508 can have a direct connection 506 to the server 106. The subscription based electrical energy information database 510 can include information from an external database that requires an account or payment to access. The information from an external database can include, for example, custom information based on an IP address associated with the gaming system 110. The server 106 can request 512 and receive 514 information from the external database.

The server 106 can provide instructions to control the gaming system 110 based on data retrieved from the one or more databases. For example, the server 106 can instruct the gaming system to reduce the speed of game downloads during a specific time period based on received electrical energy data.

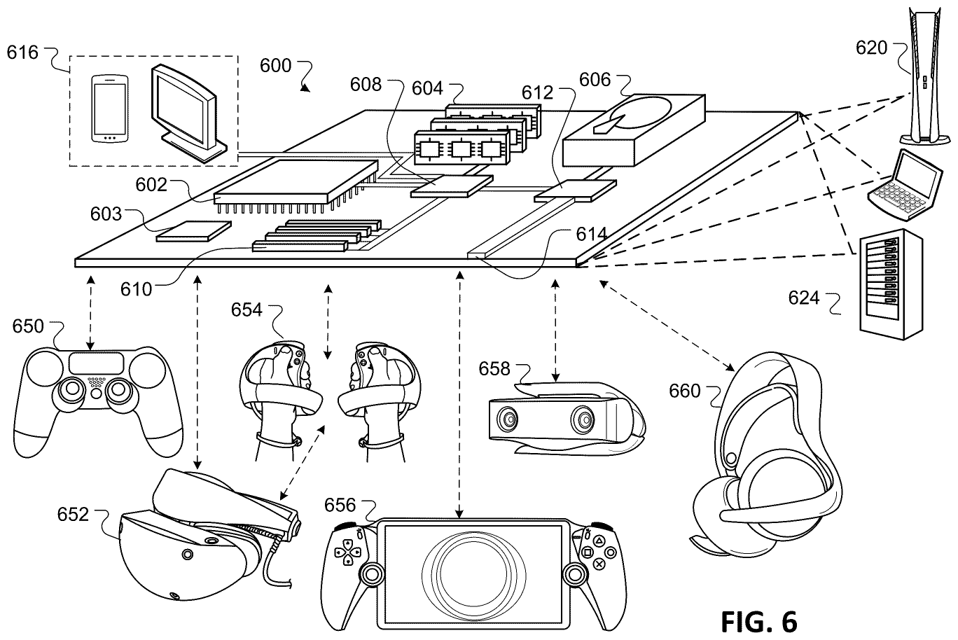

FIG. 6 shows an example of a computing device 600 and associated accessories that can be employed to execute implementations of the present disclosure. The computing device 600 is intended to represent various forms of gaming consoles such as PS5®, PS4®, PS3®, PS2® etc., desktops, workstations, personal digital assistants, servers, blade servers, mainframes, and other appropriate computers. The components shown here, their connections and relationships, and their functions, are meant to be examples only, and are not meant to be limiting. The computing device 600 can form at least a portion of a gaming system (e.g., the gaming system 110 described above with reference to FIG. 1) that can include one or more remote computing devices such as ones implementing a cloud-based portal or gaming platform.

In various implementations, the computing device 600 includes some combination of one or more processors or central processing units (CPUs) 602, one or more graphic processing units (GPUs) 603, memory 604, one or more storage devices 606, a high-speed interface 608, and/or a low-speed interface 612. In some implementations, the high-speed interface 608 connects to the memory 604 and multiple high-speed expansion ports 610. In some implementations, the low-speed interface 612 connects to a low-speed expansion port 614 and the storage device 606. In some implementations, the high-speed interface 608 connects to the storage device 606. Each of the processor 602, the GPU 603, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 (e.g., the display of the gaming system 110) coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system). The multiple computing devices can include the one or more servers 106 used for providing updates to the gaming system, performing game downloads to the gaming system, enable multiple users of the gaming system to interact with each other, and control the operations of a gaming system. More specifically, the one or more servers 106, can be used to control time periods for initiating particular functions of the gaming system.

The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk. In some implementations, the memory 604 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 606 is capable of providing mass storage for the computing device 600. In some implementations, the storage device 606 may be or include a computer-readable medium, such as a hard disk device, an optical disk device, a flash memory, or other similar solid-state memory device, or an array of devices, including devices in a storage area network or other configurations. In some implementations, the storage device 606 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 606 can be configured to support expandable storage via compatible non-volatile memory express (NVMe) SSDs. Instructions can be stored in an information carrier, and when executed by one or more processing devices, such as processor 602, perform one or more methods, such as those described above. The instructions can also be stored by one or more storage devices, such as non-transitory computer-readable or machine-readable mediums, such as the memory 604, the storage device 606, or memory on the processor 602. The instructions can constitute software for providing interactive game play on a user interface such as a graphical user interface (GUI) presented on the display 616.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 650 such as a DualSense®, DualShock®, or Access™ controllers for PlayStation® devices, a virtual reality (VR) or augmented reality (AR) headset 652 such as the PS VR2 headset, accessory controllers 654 such as PS VR2 Sense™, a handheld gaming device 656 such as PlayStation Portal®, a camera 658, and/or an earphone/headphone set 660 such as the PULSE Elite™ headset or the Pulse Explore™ earbuds. In some implementations, the computing device 600 includes one or more acoustic transducers, and/or is connected to one or more external acoustic transducers such as one or more speakers associated with the display 616.

The computing device 600 may be implemented in a number of different forms, as shown in the FIG. 6. For example, the computing device 600 may be implemented as a gaming console 620, or as one or more servers 624 or as a rack within a server. In some implementations, the computing device 600 may be implemented as a personal computer such as a laptop computer 622. In some implementations, the computing device 600 can be implemented as a mobile device such as the connected handheld gaming device 656. In some implementations, a computing device can include one or more of the computing device 600, and an entire system may be made up of multiple computing devices communicating with each other. For example, a gaming system can include one or more of a gaming console 620, one or more accessories, and a remote platform such as a cloud-based platform implemented on one or more servers 624.

The processor 602 can be implemented as a chipset of chips that include separate and multiple analog and digital processors. For example, the processor 602 can be a multi-core processor that supports high-speed processing and enables complex computational tasks, real-time physics simulations, and advanced artificial intelligence (AI) capabilities. In one example, the processor 602 includes at least 8 cores, at least 16 threads, and operates at variable frequencies around 3.5 GHz or more. In some implementations, the processor 602 may be a Complex Instruction Set Computers (CISC) processor, a Reduced Instruction Set Computer (RISC) processor, or a Minimal Instruction Set Computer (MISC) processor.

In some implementations, the GPU 603 includes a custom GPU that supports an advanced architecture such as the RDNA 2 architecture developed by AMD. In one example, the GPU 603 includes at least 36 compute units running at speeds of 2 GHz or more, and delivers performance of at least 10 teraflops. The GPU 603 can be configured to support high quality graphics rendering. For example, the GPU 603 can be configured to support hardware-accelerated ray tracing for enhanced realism in lighting and reflections, thereby providing a highly immersive gaming experience.

The computing device can be configured to interact with one or more connected input/output or accessory device in providing the gaming experience. In some implementations, the computing device communicates with a handheld controller 650—e.g., a DualSense®, DualShock®, or Access™ controller for PlayStation® devices—to provide the gaming experience. In some implementations, the controller 650 features a high-fidelity haptic feedback system with one or more actuators that simulate a wide range of tactile sensations. In some implementations the controller 650 includes one or more adaptive triggers that adjust resistance based on in-game actions to provide for a realistic feel. The ergonomic design of the controller 650 can be configured to allow for comfortable use even in long gaming sessions. For example, the controller 650 can include textured grips and an optimized button layout. In some implementations, the controller 650 includes one or more of: integrated motion sensors, a high-resolution touchpad, and a built-in microphone array. The controller 650 includes an array of buttons, joysticks, and other controls that allow a user to interact with the computing device 600 to participate in interactive gameplay presented, for example, on a display device such as the display 616. The controller 650 can be powered by one or more regular or rechargeable batteries and supports both wireless and wired connectivity with the computing device 600, for example, via Bluetooth, WiFi, USB-C etc., or via a proprietary connection such as PlayStation Link™. In some implementations, the controller 650 includes a light bar and player indicators for visual feedback and customization.

In some implementations, the input/output or accessory device includes a VR/AR headset 652. One example of such a headset is the PlayStation VR2 (PS VR2) headset that is configured to provide an immersive and interactive gaming experience. In some implementations, the headset 652 features dual organic light emitting device (OLED) displays with a combined resolution of 4000×2080 pixels—thus providing sharp visuals and a wide field of view. In some implementations, the VR/AR headset 652 includes advanced eye-tracking technology that enables foveated rendering, optimizing performance by focusing on where the user is looking. In some implementations, the headset 652 includes integrated cameras that facilitate tracking head movements without external sensors. In some implementations, the headset includes haptic feedback for tactile sensations and/or one or more acoustic transducers configured to provide a spatial sound effect the user. The headset 652 can include an adjustable headband and cushioned padding, and can be configured to connect to the computing device 600 either over a wireless network (e.g., over a WiFi® or Bluetooth® connection, or a proprietary connection such as PlayStation Link™) or over a wire such as a USB-C cable.

In some implementations, the headset 652 can be configured to work in conjunction with one or more accessory controllers 654 such as the PlayStation VR2 Sense™ controllers. The accessory controllers 654 can be configured to enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 654 can be configured to provide a comfortable experience even during extended gameplay. In some implementations, the accessory controllers include one or more integrated sensors (accelerometer, gyroscope, etc.) and cameras to provide motion tracking. The accessory controllers 654 can be configured to connect to the computing device 600 and/or the headset 652 over a wireless connection such as WiFi® or Bluetooth®.

In some implementations, the computing device 600 can be connected to a handheld gaming device 656 such as the PlayStation Portal®. The handheld gaming device 656 can be configured to stream games and media from the computing device 600 via a wireless connection such as WiFi® or Bluetooth®. The handheld gaming device 656 includes a high-resolution screen that allows users to play games and/or stream media remotely without using the display 616 connected to the computing device 600. This allows the display to be used for other purposes while the computing device 600 facilitates gameplay on the handheld gaming device 656. In some implementations, the handheld gaming device 656 is configured to act as a streaming receiver without running games natively on the device 656 itself. This makes the handheld gaming device 656 a convenient option for playing games run on the computing device 600, while leaving a TV connected to the computing device 600 free to be used for viewing other media. The handheld gaming device 656 can includes buttons and features similar to (or even same as) the controller 650, thus providing for a similar gaming experience as that with the controller 650.

In some implementations, the input/output or accessory devices can include a camera 658 and/or an earphone/headphone set 660 such as the PULSE Elite™ headset or the Pulse Explore™ earbuds. The camera 658 can be used to track user-movements, which in turn can be used as an input to an interactive game being executed on the computing device 600. The earphone/headphone set 660 can be used to provide audio feedback/output to a user from the computing device 600. In some implementations, the earphone/headphone set 660 can include a microphone configured to receive spoken inputs/instructions that in turn can be used to control an interactive game being executed on the computing device 600.

A number of implementations have been described. While this specification contains many specific implementation details, these should not be construed as limitations on the scope of what is being claimed, which is defined by the claims themselves, but rather as descriptions of features that may be specific to particular implementations of particular inventions. It will be understood that various modifications may be made.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage sub-strate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-spe-cific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in ques-tion, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or aug-mented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a mes-saging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

While operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products. Furthermore, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Accordingly, other implementations are within the scope of the claims.

What is claimed is:

1. A method for controlling an electronic gaming system, the method comprising:
receiving electrical energy data associated with one or more electrical energy sources for the electronic gaming system, the electrical energy data comprising electrical energy usage data or electrical energy supply data associated with the one or more electrical energy sources;
determining, based on at least the electrical energy data for the one or more electrical energy sources, a time-varying attribute of the one or more electrical energy sources;
selecting, based on at least the time-varying attribute of the one or more electrical energy sources, a period of time; and
causing the electronic gaming system to initiate a function during the selected period of time.

2. The method of claim 1, wherein the method further comprises:
determining a geographical location and a time of the electronic gaming system, and wherein the electrical energy data comprises electrical energy data specific to a region comprising the geographical location of the electronic gaming system.

3. The method of claim 1, wherein the electrical energy data comprises real-time electrical energy data and historical electrical energy data.

4. The method of claim 1, wherein the time-varying attribute is a proportion of available electrical energy supply of the one or more energy sources being a type of electrical energy, wherein the type of electrical energy comprises one or more of (i) stored battery energy, (ii) solar energy, (iii) wind energy, (iv) hydroelectric energy, (iv) geothermal energy, or (v) nuclear energy.

5. The method of claim 1, wherein the time-varying attribute is an electrical energy load on the one or more electrical energy sources.

6. The method of claim 1, wherein the one or more electrical energy sources comprises an on-site electrical energy system configured to supply electrical energy to the electronic gaming system.

7. The method of claim 6, wherein the one or more electrical energy sources comprise a plurality of electrical energy sources, and wherein the plurality of electrical energy sources further comprises an off-site electrical energy source configured to supply electrical energy to the electronic gaming system.

8. The method of claim 7, wherein the time-varying attribute corresponds to a proportion of available electrical energy of the on-site electrical energy source, and wherein the electrical energy configured to be supplied by the on-site electrical energy source is generated by a renewable energy source.

9. The method of claim 1, wherein selecting the period of time comprises predicting a value of the time-varying attribute during the period of time.

10. The method of claim 1, wherein the function comprises download of a game to the electronic gaming system or download of a patch update to the electronic gaming system, and wherein the download of the game or the download of the patch update comprises a download at a reduced speed.

11. The method of claim 1, wherein the function comprises presentation of a recommendation to a user of the electronic gaming system to alter a behavior of the user for using the electronic gaming system.

12. The method of claim 1, wherein the function results in a change in power consumption of the electronic gaming system.

13. The method of claim 12, wherein the function comprises an adjustment of one or more characteristics of imagery generated by the electronic gaming system.

14. The method of claim 13, wherein the one or more characteristics of the imagery comprise frame rate.

15. The method of claim 13, wherein the one or more characteristics of the imagery comprise brightness.

16. The method of claim 13, wherein the one or more characteristics of the imagery comprise resolution.

17. The method of claim 1, wherein the function comprises use of a cloud version of the game during the period of time.

18. A computer system comprising:
one or more processors; and
memory coupled to the one or more processors and having encoded thereon instructions for causing the one or more processors to execute a method for controlling an electronic gaming system, the method comprising:
receiving electrical energy data associated with one or more electrical energy sources for the electronic gaming system, the electrical energy data comprising electrical energy usage data or electrical energy supply data associated with the one or more electrical energy sources;
determining, based on at least the electrical energy data for the one or more electrical energy sources, a time-varying attribute of the one or more electrical energy sources;
selecting, based on at least the time-varying attribute of the one or more electrical energy sources, a period of time; and
causing the electronic gaming system to initiate a function during the selected period of time.

19. The computer system of claim 18, wherein the method further comprises:
determining a geographical location and a time of the electronic gaming system, and wherein the electrical energy data comprises electrical energy data specific to a region comprising the geographical location of the electronic gaming system.

20. The computer system of claim 18, wherein selecting the period of time comprises predicting a value of the time-varying attribute during the period of time.

21. The computer system of claim 18, wherein the function comprises download of a game to the electronic gaming system or download of a patch update to the electronic gaming system, and wherein the download of the game or the download of the patch update comprises a download at a reduced speed.

22. The computer system of claim 18, wherein the function results in a change in power consumption of the electronic gaming system.

23. The computer system of claim 22, wherein the function comprises an adjustment of one or more characteristics of imagery generated by the electronic gaming system.

24. The computer system of claim 23, wherein the one or more characteristics of the imagery comprise frame rate.

25. The computer system of claim 23, wherein the one or more characteristics of the imagery comprise brightness.

26. The computer system of claim 23, wherein the one or more characteristics of the imagery comprise resolution.

27. One or more non-transitory machine-readable storage devices having encoded thereon instructions for causing one or more processing devices to perform a method for controlling an electronic gaming system, the method comprising:
receiving electrical energy data associated with one or more electrical energy sources for the electronic gaming system, the electrical energy data comprising electrical energy usage data or electrical energy supply data associated with the one or more electrical energy sources;
determining, based on at least the electrical energy data for the one or more electrical energy sources, a time-varying attribute of the one or more electrical energy sources;
selecting, based on at least the time-varying attribute of the one or more electrical energy sources, a period of time; and
causing the electronic gaming system to initiate a function during the selected period of time.

28. The non-transitory machine-readable storage devices of claim 18, wherein the method further comprises:
determining a geographical location and a time of the electronic gaming system, and wherein the electrical energy data comprises electrical energy data specific to a region comprising the geographical location of the electronic gaming system.

29. The non-transitory machine-readable storage devices of claim 18, wherein selecting the period of time comprises predicting a value of the time-varying attribute during the period of time.
